(19) United States
(12) Patent Application Publication
(10) Pub. No.: US 2026/0237386 A1
(43) Pub. Date: Aug. 13, 2026

(54) IMPROVING SPEECH UNDERSTANDING OF USERS

(71) Applicant: Massachusetts Institute of Technology, Cambridge, MA (US)

(72) Inventors: Haruhiko Harry Asada, Lincoln, MA (US); Ravi Tejwani, Cambridge, MA (US)

(73) Assignee: Massachusetts Institute of Technology, Cambridge, MA (US)

(21) Appl. No.: 19/154,204

(22) PCT Filed: Feb. 7, 2024
(86) PCT No.: PCT/US2024/014822

§ 371 Date: Aug. 6, 2025

Related U.S. Application Data
(60) Provisional application No. 63/483,800, filed on Feb. 8, 2023.

(51) Int. Cl. G10L 15/22; G02B 27/01; G06T 19/00

(52) U.S. Cl. CPC G10L 15/22; G02B 27/017; G06T 19/006

(57) ABSTRACT

The techniques described herein relate to systems, apparatus, articles of manufacture, and methods for improving speech understanding of users. An example method includes obtaining at least one speech comprehension metric indicating a degree to which the user comprehends audible speech. The method further includes obtaining speech information to be output to the user, the speech information representing audible speech communicated to the user. The method additionally includes determining modulated speech information using a cognitive speech model with the at least one speech comprehension metric and the speech information, and outputting the modulated speech information to the user.

### RELATED APPLICATION

This patent claims priority under 35 U.S.C. § 119(e) to U.S. Provisional Application No. 63/483,800, filed on Feb. 8, 2023, which is hereby incorporated by reference herein in its entirety.

### FIELD

The techniques described herein relate generally to speech processing and, more particularly, to improving speech understanding of users.

### BACKGROUND

People experience hearing difficulties as they age. Hearing high tones and high-pitch voices, in particular, is a challenge for many older adults. For people that develop dementia, the situation becomes more challenging for them. The duration, speed, and complexity of speech may frustrate many of these persons when comprehending audible speech. Further, people with dementia may also have difficulty understanding words as well as contexts surrounding conversations due to declining ability in processing auditory information.

### SUMMARY

In accordance with the disclosed subject matter, systems, apparatus, articles of manufacture, and methods are provided for improving speech understanding of users.

Some embodiments relate to a method for improving speech understanding of a user. The method comprises obtaining at least one speech comprehension metric indicating a degree to which the user comprehends audible speech, obtaining speech information to be output to the user, the speech information representing audible speech communicated to the user, determining modulated speech information using a cognitive speech model with the at least one speech comprehension metric and the speech information; and outputting the modulated speech information to the user.

Some embodiments relate to at least one non-transitory computer-readable storage medium comprising processor executable instructions that, when executed by at least one hardware processor, cause the at least one hardware processor to perform a method comprising: obtaining at least one speech comprehension metric indicating a degree to which the user comprehends audible speech, obtaining speech information to be output to the user, the speech information representing audible speech communicated to the user, determining modulated speech information using a cognitive speech model with the at least one speech comprehension metric and the speech information; and outputting the modulated speech information to the user.

Some embodiments relate to a system for improving speech understanding of a user. The system comprises at least one memory storing processor-executable instructions; and at least one hardware processor configured to execute the processor-executable instructions to: obtain at least one speech comprehension metric indicating a degree to which a user comprehends audible speech, obtain speech information to be output to the user, the speech information representing audible speech communicated to the user, determine modulated speech information using a cognitive speech model with the at least one speech comprehension metric and the speech information, and output the modulated speech information to the user.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. In the figures, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 is a system including a speech understanding improvement service for improving speech understanding of a user, according to some embodiments.

FIG. 2 is a system including the speech understanding improvement service of FIG. 1 for improving the understanding of speech from an avatar, according to some embodiments.

FIG. 3 is a block diagram of an example implementation of the speech understanding improvement service of FIGS. 1 and/or 2, according to some embodiments.

FIG. 4 is a workflow of example operations that may be performed and/or executed to improve speech understanding of a user, according to some embodiments.

FIG. 5 is a flowchart representative of an example process that may be performed and/or example machine-readable instructions that may be executed by processor circuitry to implement the speech understanding improvement service of FIGS. 1, 2, and/or 3 to output modulated speech information to a user, according to some embodiments.

FIG. 6 is a flowchart representative of an example process that may be performed and/or example machine-readable instructions that may be executed by processor circuitry to implement the speech understanding improvement service of FIGS. 1, 2, and/or 3 to train a cognitive speech model for inference operations, according to some embodiments.

FIG. 7 is an example electronic platform structured to execute the machine-readable instructions of FIGS. 5 and/or 6 to implement the speech understanding improvement service of FIGS. 1, 2, and/or 3, according to some embodiments.

### DETAILED DESCRIPTION

Age-related hearing loss impacts speech perception, often making high frequencies and complex speech difficult to understand. Examples of age-related hearing loss include people with presbycusis and/or dementia. Presbycusis is a condition characterized by the gradual loss of hearing in one or both ears and is a common problem linked to aging. Typically, presbycusis affects a person's ability to hear high-pitched noises such as a phone ringing or a beeping of a kitchen appliance. Dementia refers to a group of conditions characterized by loss of language, memory, problem-solving, and other thinking abilities that are severe enough to interfere with daily life. Hearing loss is linked to social isolation, depression, and cognitive decline among older adults.

The inventors have recognized that different types of users have difficulty understanding speech. One type of user is hard of hearing, such as having auditory deficits. This type of user may have a range of ages, such as (i) younger users who may have a genetic condition or experienced a traumatic event causing the auditory deficits or (ii) older users with presbycusis. Such users may have challenges when hearing high tones and high-pitches voices. Users hard of hearing may experience that their hearing and/or understanding capabilities may degrade over time.

Another type of user having difficulty understanding speech is a person with dementia. This type of user has challenges with the duration, speed, and/or complexity of audible speech. For example, speech duration may pose challenges to users with dementia because long sentences may be difficult to understand and tend to cause frustration and/or confusion with such users. Speech speed may also present challenges to such users because a user with dementia may feel that the speed of speech is significantly faster than those without dementia. Users with dementia may be unable to understand speech unless it is spoken very slowly or broken into shorter speech portions. Further, complexity of speech may confuse and/or frustrate a user with dementia if spoken statements require inference and reasoning, which makes it significantly more difficult for users with declining ability in processing auditory information to understand. Users with dementia may experience that their hearing and/or understanding capabilities may degrade over time.

The inventors have recognized that conventional techniques for improving speech understanding of users do not overcome all the challenges presented to hard of hearing and/or dementia users. One such conventional technique is using a hearing aid. Hearing aids are electronic devices that may be worn in or behind the ears. Hearing aids may process sound by amplifying received audio, rejecting background noise, and suppressing other unwanted sounds such as suppressing transient loud noises through impulse noise rejection. Users may adjust hearing aids by making manual adjustments. Examples of manual adjustments include turning a volume control up or down, changing a frequency response of the hearing aid (e.g., changing which channels of frequencies are amplified), and pushing a button on the hearing aid to reduce noise coming from behind the user.

The inventors have recognized several problems with conventional hearing aids. First, while hearing aids may be beneficial for some users, many older users struggle with device use and challenges in auditory perception remain. Second, while hearing aids may offer some manual adjustment capability, the range of available adjustments is limited. For example, hearing aids may not offer an expansive range of acoustic feature adjustments to hearing aid outputs.

Third, conventional hearing aids are unable to change the content of their output and/or the manner of audible delivery. For example, conventional hearing aids do not change, convert, and/or translate a speaker's audible speech into speech that is more easily understood by a hearing-aid user. In such an example, hearing aids do not break up longer sentences into shorter sentences and/or fragments. Such hearing aids also do not convert complex speech into simpler speech, such as by substituting complex terms for simpler terms.

Fourth, conventional hearing aids do not learn user preferences over time and therefore are unable to proactively change their settings to improve the user experience. For example, such hearing aids may rely on continuous manual adjustments by users over time for improved hearing aid operation. Fifth, conventional hearing aids do not improve the hearing experience for a user based on feedback from the user. For example, conventional hearing aids do not change their operation, such as by modifying their outputs to a user, based on whether a user understood a speaker's audible speech.

The inventors have also recognized that conventional speech dialogue systems may use machine learning to improve speech understanding of a user. However, the inventors have recognized multiple problems with such systems. First, some such systems may operate in an open-loop manner with no adaptation to individual users. For example, a machine learning model may be trained using data from the public at large and not from a particular user. A machine learning model trained on such non-personalized data may be deployed to a plurality of users without customization and/or learning in accordance with each user's hearing needs and/or abilities. Second, machine learning models may be trained using homogeneous data, such as only audio data, rather that heterogeneous data, which may include different types of data such as audio, image, and biometric data. Machine learning models trained using only a certain type of data, such as audio data, may not provide improvement to speech understanding by certain users, such as users who are non-verbal.

The inventors have developed technology that improves speech understanding of users. The technology modifies audio information for output to a user in accordance with the user's audio preferences such that the output improves audibility and understanding for the user. Examples of audio information include recorded, generated, and commanded audio information (e.g., audio representing commands, directions, or instructions to a user). For example, the audio information can represent audible speech in a user's environment or recorded speech (e.g., pre-recorded speech).

The technology modifies the audio information based on at least one speech comprehension metric indicating a degree to which a user comprehends audible speech. For example, the technology can change one or more acoustic features of audio information representing speech to improve the user's audibility and understanding of the speech. Examples of acoustic features include duration, inflection, intonation, phasing, pitch, stress, tempo, tone, or volume of the audible output. For example, the at least one speech comprehension metric can indicate that the user has difficulty with understanding long sentences (e.g., the user has dementia). In such an example, the technology segments a long spoken sentence into multiple shorter sentences or fragments for output to the user.

The technology includes using a cognitive speech model that ingests audio information and at least one speech comprehension metric as inputs to generate new speech as output. The technology includes determining the at least one speech comprehension metric using feedback from a user such that the at least one speech comprehension metric is customized and/or tailored to the user. Examples of feedback include audible speech information of a user and biometric data. For example, in response to audible speech in a user's environment, the technology can record speech spoken by the user and/or biometric data of the user. In such an example, the technology includes using at least one model to determine an emotional state of the user based on the recorded spoken speech and/or the biometric data. Examples of the user's emotional state include confusion, frustration, surprise, anger, happy, and disgust. For example, the at least one model can be executed to determine whether the user is confused and/or frustrated when comprehending audible speech in the user's environment. The at least one model can be executed to output the degree to which the user is in a particular emotional state, such as a degree to which the user is confused and/or frustrated, as the at least one speech comprehension metric. The technology includes providing the at least one speech comprehension metric as feedback to the cognitive speech model to improve its operation. For example, the cognitive speech model can be retrained, using the feedback, to generate and output modified audio information to improve speech understanding of a user.

The technology developed by the inventors has many benefits and overcomes the challenges of conventional hearing aids and conventional speech dialogue systems. First, changing acoustic feature(s) of audio information in accordance with user audio preferences and/or at least one speech comprehension metric for the user overcomes the problem of conventional hearing aids being unable to change their manner of delivery (e.g., breaking longer sentences into shorter sentences or fragments).

Second, improving the cognitive speech model over time by using feedback from a user overcomes the problem of conventional hearing aids not learning user preferences and/or degradation in a user's condition over time. For example, such learning over time by the cognitive speech model overcomes the problem of conventional hearing aids not improving based on user feedback. Further, such learning overcomes the problem of open loop machine learning models that do not generate speech output personalized to a user. Third, determining at least one speech comprehension metric using heterogeneous data, such as audible speech information and biometric data, overcomes the problem of machine learning models providing non-personalized speech output because they are trained on homogeneous data.

The techniques described herein may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

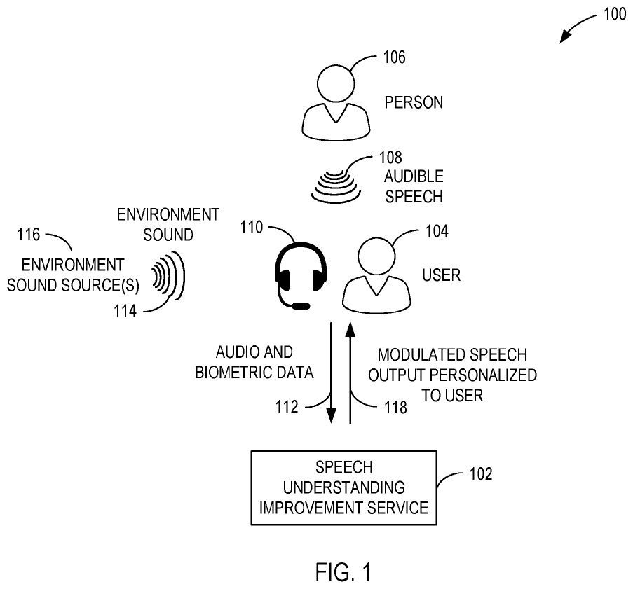

Turning to the figures, the illustrated example of FIG. 1 is a system 100 including a speech understanding improvement service 102 for improving speech understanding of a user 104. The system 100 is used to enhance communication between the user 104 and a person 106. The user 104 of this example is a human person that has challenges with understanding speech. For example, the user 104 can be a person that is hard of hearing and/or has dementia. The person 106 of this example is a human person that is speaking, such as by providing audible speech 108, in an environment of the user 104. For example, the person 106 can be a caregiver, a clinician (e.g., a nurse, a medical doctor), a practitioner (e.g., an occupational therapist, a speech therapist), and/or a relative.

The system 100 of this example can correspond to a specific application area. Examples of application areas include media streaming (e.g., electronic delivery of books, movies, music, television), communications for in-home care, and communications for remote care. For example, the system 100 can represent an in-home care application and the audible speech 108 can represent spoken communication by an in-person caregiver to the user 104. By way of another example, the system 100 can represent remote care. Examples of remote care include telemedicine conversation and communications for remote home care and monitoring. For example, the person 106 can be in a different location than the user 104 and the audible speech 108 can represent auditory signals captured via microphone(s) at the remote location of the person 106. In such an example, the auditory signals can be processed by a network (e.g., a cloud computing network, an edge computing network) before reaching an electronic device 110 of the user 104.

The electronic device 110 shown in FIG. 1 is a headset. Examples of headsets include an audio headset (e.g., headphones, ear buds), an augmented reality (AR) headset, and a virtual reality (VR) headset. Alternatively, the electronic device 110 may be a device with at least one audio output device (e.g., a speaker). Examples of devices with at least one audio output device include a laptop computer, a tablet computer, a cellular phone (e.g., a smartphone), a television (e.g., a smart television), a streaming device, or a wearable device (e.g., a smartwatch, smart glasses).

In the illustrated example, the electronic device 110 obtains input information 112 for processing by the speech understanding improvement service 102. The input information 112 of FIG. 1 includes audio information (e.g., audio data) and/or biometric information (e.g., biometric data). For example, the electronic device 110 can include one or more audio sensors to capture and/or receive sound. Examples of audio sensors include a microphone and a microphone array. Examples of audio information include captured, recorded, generated, and commanded audio data (e.g., audio data representing commands, directions, or instructions from the person 106 to the user 104). For example, the audio information can include the audible speech 108 and/or environment sound 114 from environment sound source(s) 116. Examples of the audible speech 108 include pre-recorded speech and dynamically generated speech. For example, the audible speech 108 can be pre-recorded commands to carry out an occupational therapy session. In another example, the audible speech 108 can be spoken by the person 106 in the physical presence of the user 104 or remotely from a different location than the user 104.

The environment sound 114 of the shown example represents background noise and/or sounds in an environment of the user 104. For example, the environment sound 114 can include animal sounds from pets in the environment of the user 104, sounds from a household appliance (e.g., a washer, a dryer, a dishwasher), music, a nearby crowd of people, and/or sounds from vehicles external to the environment of the user 104 (e.g., vehicles outside a window and/or otherwise external to a residence of the user 104).

In the illustrated example, the electronic device 110 obtains biometric information of the user 104. For example, the electronic device 110 can include one or more sensors that measure and/or generate biometric data of the user 104. Examples of sensors include a camera, a heart rate monitor (e.g., an optical heart rate monitor), an inertial measurement unit (e.g., an accelerometer, a gyroscope), a light detection and ranging (LIDAR) scanner, a microphone or microphone array, a pulse monitor (e.g., an optical pulse monitor), a skin conductance sensor (e.g., a galvanic skin response sensor, an electrodermal activity sensor), and any other sensor configured to monitor a person's physical attributes or behavioral attributes (e.g., facial features, vocals). Examples of cameras include high-resolution cameras, eye-tracking cameras, and stereoscopic cameras.

In some embodiments, the electronic device 110 includes and/or implements a user interface to receive audio preferences of the user 104. For example, the user interface can be implemented by one or more buttons, dials, switches, touchpads, and/or touchscreens of the electronic device 110. In another example, the user interface can be implemented using audio prompts by the electronic device 110 such that the user 104 may provide audible preferences via spoken commands. Examples of the audio preferences include preferences for higher frequency of tone and pitch, longer pauses, higher vowel stretches to add length to words, and percentage of text split.

The speech understanding improvement service 102 depicted in FIG. 1 processes the input information 112 for generation of output information 118 to the user 104. The output information 112 of this example is modulated speech output personalized to the user 104. For example, the speech understanding improvement service 102 can adjust, change, and/or modify aspect(s) of the audible speech 108, such as acoustic feature(s) and/or speech content, to generate modulated speech for output to the user 104. The speech understanding improvement service 102 can output the modulated speech to the user 104 using one or more audio output devices. An example of an audio output device is a speaker. For example, the electronic device 110 can be an augmented reality headset that includes one or more speakers for delivery of modulated speech to a user using sound.

The speech understanding improvement service 102 of the illustrated example generates and/or outputs modulated speech personalized to the user 104. The speech understanding improvement service 102 of this example is software. Alternatively, the speech understanding improvement service 102 may be a combination of software and/or firmware. The speech understanding improvement service 102 of this example is separate from the electronic device 110. For example, the speech understanding improvement service 102 can be in communication with the electronic device 110 via one or more networks. In some embodiments, the electronic device 110 include, implement, and/or execute one or more portion(s) of the speech understanding improvement service 102. For example, at least part of the speech understanding improvement service 102 can be integrated into the electronic device 110.

The one or more networks (not shown but nevertheless may be included in the system 100 of FIG. 1) may be implemented by any wired and/or wireless network(s) such as one or more cellular networks (e.g., 4G LTE cellular networks, 5G cellular networks, future generation 6G cellular networks, etc.), one or more local area networks (LANs), one or more optical fiber networks, one or more cloud networks (e.g., a network provided by a public cloud provider, a network provided by a private cloud provider), one or more edge networks, one or more private networks, one or more public networks, one or more satellite networks, one or more wireless local area networks (WLANs), etc., and/or any combination(s) thereof. For example, the one or more networks may be implemented at least in part by the Internet, but any other type of private and/or public network is contemplated.

The speech understanding improvement service 102 of the illustrated example generates and/or outputs modulated speech personalized to the user 104 in accordance with and/or based on at least one speech comprehension metric associated with the user 104. The at least one speech comprehension metric can indicate a degree to which the user 104 comprehends speech.

In some embodiments, the at least one speech comprehension metric represents a degree to which the user 104 comprehends speech when the user 104 is hard of hearing. For example, the at least one speech comprehension metric can represent a degree to which the user 104 can hear and/or perceive high tones, high pitches, or various qualities of sound (e.g., timbre). In such an example, the at least one speech comprehension metric can indicate that the user 104 is unable to or has challenges comprehending the audible speech 108 when the audible speech 108 has high tones and/or high pitches.

In some embodiments, the at least one speech comprehension metric represents a degree to which the user 104 comprehends speech when the user has dementia. For example, the at least one speech comprehension metric can represent a degree to which the user 104 can comprehend and/or understand speech of varying duration, speed, and/or complexity. In such an example, the at least one speech comprehension metric can indicate that the user 104 is unable to or has challenges comprehending the audible speech 108 when the audible speech 108 includes long sentences. By way of another example, the at least one speech comprehension metric can indicate that the user 104 is unable to or has challenges comprehending the audible speech 108 when the audible speech 108 is spoken quickly. By way of yet another example, the at least one speech comprehension metric can indicate that the user 104 is unable to or has challenges comprehending the audible speech 108 when the audible speech 108 requires inference and reasoning.

In example operation, the speech understanding improvement service 102 obtains at least one speech comprehension metric indicating a degree to which the user 104 comprehends audible speech. For example, the speech understanding improvement service 102 can obtain at least one speech comprehension metric that was previously determined for the user 104 during a calibration and/or configuration process of the electronic device 110 for operation by the user 104. By way of another example, the speech understanding improvement service 102 can obtain at least one speech comprehension metric by determining the at least one speech comprehension metric in response to the user 104 hearing the audible speech 108.

In example operation, the speech understanding improvement service 102 obtains speech information to be output to the user 104. For example, the electronic device 110 can receive audio information output from a microphone. In such an example, the audio information can represent the audible speech 108 captured by the microphone and to be output to the user 104.

In example operation, the speech understanding improvement service 102 determines modulated speech information using a cognitive speech model with the at least one comprehension metric and the speech information. By way of example, the cognitive speech model can modulate acoustic features of the audible speech 108 in accordance with audio preference information representing audible speech output preferences of the user 104. Examples of audio speech output preferences include levels or specifications for inflection, intonation, phasing, pitch, stress, tempo, tone, and volume characteristics of audible speech output from the electronic device 110 to the user 104. The cognitive speech model can determine the modulated speech information by modulating the acoustic features of the audible speech 108 in accordance with the user audio preference information. For example, the cognitive speech model can amplify high pitches and/or high tones of the audible speech 108 if the at least one speech comprehension metric indicates that the user 104 is hard of hearing.

By way of another example, the cognitive speech model can modulate the audible speech 108, by changing the content and/or manner of delivery of the audible speech 108 to the user 104, to generate the modulated speech output. For example, the cognitive speech model can alter, change, and/or modify the audible speech 108 in accordance with the at least one speech comprehension metric, associated with the user 104, that indicates a degree to which the user comprehends audible speech. In such an example, the cognitive speech model can break up one or more longer sentences of the audible speech 108 into multiple shorter sentences or fragments if the at least one speech comprehension metric indicates that the user 104 has dementia and/or otherwise has difficulty understanding longer duration speech.

In example operation, the speech understanding improvement service 102 outputs the modulated speech information to the user 104. For example, the speech understanding improvement service 102 can output modulated speech information for output to the user 104 using at least one audio output device of the electronic device 110. In such an example, at least one speaker of the electronic device 110 can play and/or output the modulated speech information, which can correspond to the audible speech 108 but with amplifications of high pitches and/or high tones of the audible speech 108. In another example, the at least one speaker of the electronic device 110 can output modulated speech implemented by shorter sentences or speech fragments instead of the long sentences of the audible speech 108 for improved speech understanding of the user 104.

In some embodiments, the speech understanding improvement service 102 can be executed and/or operated for transforming and translating the original speech of the person 106 into a desirable tone, format, and expression and presenting the modulated speech to the user 104 via the electronic device 110. Examples of transforming and translating functions are provided.

A first transforming and translation function is adjustment of tone and/or volume. Because high-pitch voice and high tone are difficult for the user 104 to process, the speech understanding improvement service 102 may shift the tone of the audible speech 108 from a high frequency range to a low frequency range.

A second transforming and translation function is adjustment of speech speed.

Because the user 104 may experience difficulties when listening to fast speech, the speech understanding improvement service 102 may reduce the speed of the audible speech 108 when presented to the user 104.

A third transforming and translation function is expression segmentation. For example, if the sentence spoken by the person 106 is long, the speech understanding improvement service 102 may rephrase the expression such that the expression may be simplified and/or segmented into portions (e.g., shorter sentences, sentence fragments) to improve speech understanding of the user 104.

A fourth transforming and translation function is expression rephrasing. For example, if the sentence spoken by the person 106 requires reasoning and inference, the speech understanding improvement service 102 may rephrase the sentence to a series of short sentences that do not require reasoning and inferences.

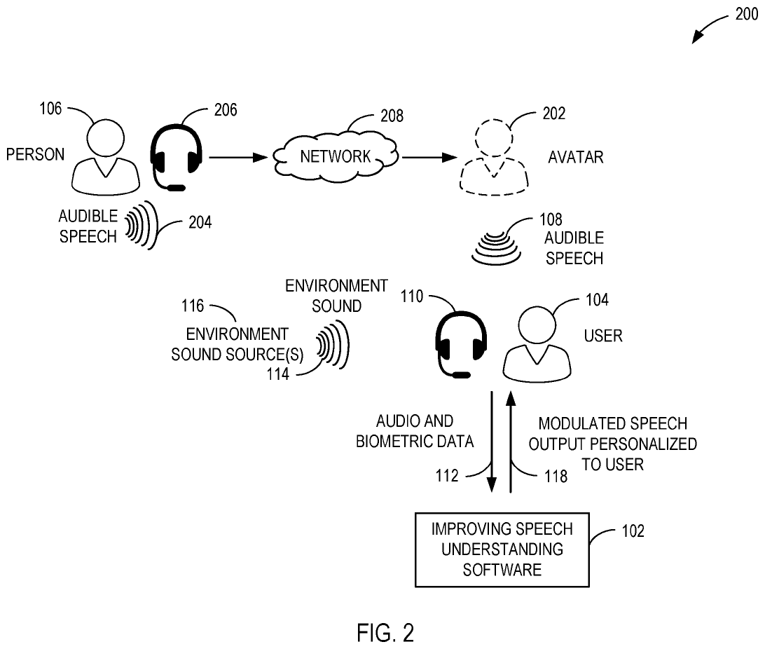

FIG. 2 is a system 200 including the speech understanding improvement service 102 of FIG. 1 for improving the understanding of speech from an avatar 202. In the example of FIG. 2, the avatar 202 is a representation of the person 106 of FIG. 1. For example, the avatar 202 can be implemented by an augmented reality overlay over a physical human-shaped object in the presence of the user 104, such as a robot or other machine. In such an example, the user 104 can perceive the avatar 202 as a familiar person, such as a caregiver, a clinician, a practitioner, and/or a relative. In another example, the avatar 202 can be implemented by a virtual reality visualization of the person 106 such that the person 106 appears to the user 104 to be in the physical presence of the user 104 but is at a remote location different from the location of the user 104.

An example application of the system 200 shown in FIG. 2 is remote care such as a telemedicine conversation and/or communications for remote home care and monitoring. For example, the person 106 shown in FIG. 2 can be an occupational therapist treating the user 104. In such an example, the person 106 can provide audible commands as the audible speech 204. Examples of audible commands include instructing the user 104 to raise a limb (e.g., raising a hand, a foot, a leg), manipulate object(s) with one or both hands, move (e.g., walk, run, jump, perform a physical stretch), and speak.

In the illustrated example, the person 106 provides audible speech 204 to the user 104 by speaking into an audio input device, such as a microphone, of an electronic device 206. Examples of the electronic device 206 include a laptop computer, a tablet computer, a cellular phone (e.g., a smartphone), a television (e.g., a smart television), a streaming device, a headset (e.g., an audio headset, an augmented reality headset, a virtual reality headset), or a wearable device (e.g., a smartwatch, smart glasses). The electronic device 206 can transmit and/or cause transmission of data representing the audible speech 204 over a network 208. For example, the avatar 202 can be implemented at least in part by a robot or other machine with at least one audio output device. In such an example, the at least one audio output device can play and/or output the audible speech 204 as the audible speech 108 heard by the user 104. In another example, the avatar 202 can be implemented only by a visual representation. In such an example, the audible speech 204 can be transmitted to the electronic device 110, via the network 208, to cause the at least one audio output device of the electronic device 110 to play and/or output the audible speech 204 to the user 104.

The network 208 of the illustrated example may be implemented by any wired and/or wireless network(s) such as one or more cellular networks (e.g., 4G LTE cellular networks, 5G cellular networks, future generation 6G cellular networks, etc.), one or more cloud networks, one or more edge networks, one or more data buses, one or more LANs, one or more optical fiber networks, one or more private networks, one or more public networks, one or more satellite networks, one or more WLANs, etc., and/or any combination(s) thereof. For example, the network 208 may be the Internet, but any other type of private and/or public network is contemplated.

In the illustrated example of FIG. 2, the speech understanding improvement service 102 obtains the input information 112 as described in connection with FIG. 1. The speech understanding improvement service 102 of the shown example processes the input information 112 for generation of the output information 118 to the user 104 as described in connection with FIG. 1. For example, the speech understanding improvement service 102 can process the audible speech 108, which can be provided from the person 106 and/or from the person 106 via the avatar 202, into modulated speech output personalized to the user.

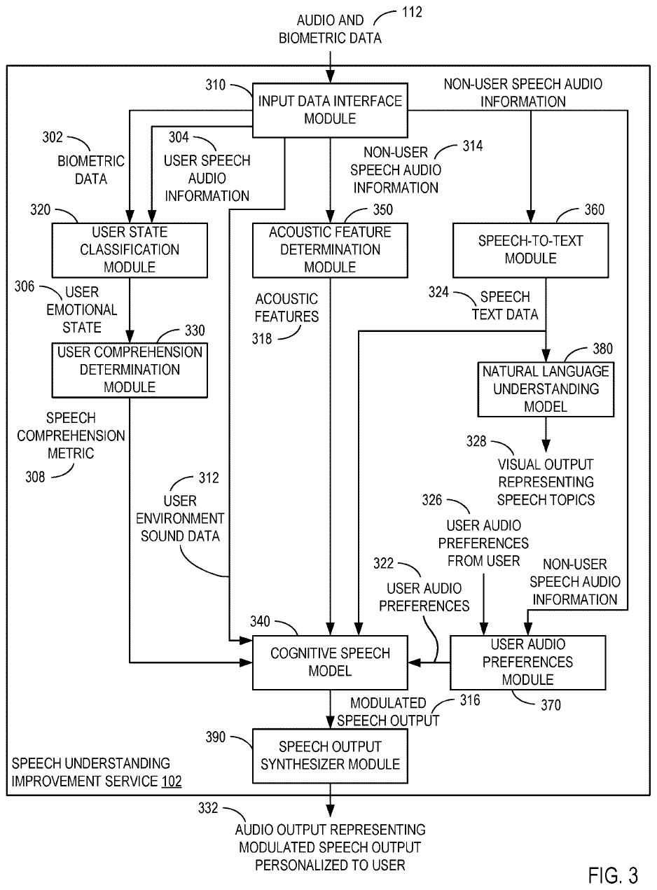

FIG. 3 is a block diagram of an example implementation of the speech understanding improvement service 102 of FIGS. 1 and/or 2. The speech understanding improvement service 102 shown in FIG. 3 can be configured to generate at least one speech comprehension metric indicative of a degree to which the user 104 of FIGS. 1 and/or 2 comprehends speech. After generating the at least one speech comprehension metric, the speech understanding improvement service 102 can modulate speech information (e.g., recorded speech information, captured speech information) to be provided to the user 104 in accordance with the at least one speech comprehension metric to improve speech understanding of the user 104.

In the illustrated example, the speech understanding improvement service 102 generates at least one speech comprehension metric via the left branch of the implementation shown in FIG. 3. The speech understanding improvement service 102 includes an input data interface module 310 configured to receive input information, such as the input information 112 of FIG. 1. For example, the input data interface module 310 can be configured to receive audio information and/or biometric information.

In the illustrated example, the input data interface module 310 is configured to receive audio information, which may include audio data representing the audible speech 108 of FIGS. 1-2, the environment sound 114 of FIGS. 1-2, and/or the audible speech 204 of FIG. 2. Examples of audio data include amplitude data, frequency data, pulse code modulation (PCM) data, spectrograms, and waveform data. In some embodiments, the input data interface module 310 can be configured to receive audio data in a lossless file format or a lossy file format. Examples of lossless file formats include the Audio Interchange File Format (AIFF) and the Free Lossless Audio Codec (FLAC). Examples of lossy file formats include Advanced Audio Coding (AAC), MPEG-1 Audio Layer III (MP3), and Ogg Vorbis. In some embodiments, the input data interface module 310 is configured to receive and/or decompress compressed audio data.

In the illustrated example, the input data interface module 310 is configured to receive biometric information. For example, the input data interface module 310 can be configured to receive and/or process the biometric data of the user 104 of FIGS. 1-2. In some embodiments, the input data interface module 310 is configured to receive and/or decompress compressed biometric information. Examples of the biometric information for the user 104 include images and/or video of the user's face, heart rate data, pulse data, and motion data. In some embodiments, the images and/or video of the user's face may be used for facial recognition and/or eye tracking as explained further below.

The input data interface module 310 is shown in FIG. 3 to output biometric data 302 and user speech audio information 304 to a user state classification module 320. For example, the input data interface module 310 can extract the biometric data 302 and the user speech audio information 304 from the input information 112 and output the extracted biometric data 302 and the user speech audio information 304 to the user state classification module 320.

In some embodiments, the biometric data 302 is raw and/or unprocessed biometric data, such as raw and/or unprocessed image data, video data, heart rate data, pulse data, and/or motion data. Alternatively, the biometric data 302 may be processed biometric data, such as by removing outlier data or performing noise rejection operations on the biometric information.

In some embodiments, the user speech audio information 304 is audio data that represents speech spoken by the user 104. For example, the user speech audio information 304 can represent speech spoken by the user 104 in response to the user 104 hearing the audible speech 108 and/or comprehending the audible speech 108. In such an example, the speech understanding improvement service 102 can use the user speech audio information 304 as feedback from the user 104 to generate the at least one speech comprehension metric and/or update the at least one speech comprehension metric over time.

In some embodiments, the user speech audio information 304 is raw and/or unprocessed audio data, such as raw and/or unprocessed amplitude data, frequency data, PCM data, spectrogram data, and/or waveform data. Alternatively, the user speech audio information 304 may be processed audio data, such as by removing outlier data or performing noise rejection operations on the audio information.

The user state classification module 320 is configured to process the biometric data 302 and/or the user speech audio information 304 into a user emotional state 306 (e.g., data representing the user emotional state 306). In some embodiments, the user state classification module 320 is implemented at least in part by one or more models. Examples of the one or more models include artificial intelligence (AI) and/or machine learning (ML) models (AI/ML models), natural language processing (NLP) models, computer-implemented decision trees, Markov Chains, template-based generation models, and context-free grammars (CFGs). An example of AI/ML models include neural networks (NNs) and NLP models. Examples of NNs include convolutional neural networks (CNNs), deep neural networks (e.g., deep convolutional networks (DCNs), deep feed forward (DFF) neural networks), feed forward (FF) NNs, generative adversarial networks (GANs), and recurrent neural networks (RNNs). Examples of NLP models include RNNs, long short-term memory networks (LSTMs), and transformers.

In some embodiments, the user state classification module 320 executes at least one ML model to implement facial expression recognition (FER). FER is a computer vision task for identifying and classifying emotional expressions depicted on a human face. For example, the user state classification module 320 can execute at least one ML model using the biometric data 302 as ML input, which may include image(s) and/or video of the face of the user 104, to generate ML output. The ML output shown in FIG. 3 is the user emotional state 306. For example, the user state classification module 320 can execute at least one ML model to perform FER using the biometric data 302 of the face of the user 104 to determine the user emotional state 306. Examples of the emotional user state 306 include confusion (e.g., a confused user state), frustration (e.g., a frustrated user state), and neutral (e.g., a blank face or a user state indicating that the user 104 is not expressing an emotion). For example, the user state classification module 320 can determine, using the biometric data 302 of the user 104, whether the user 104 is confused and/or frustrated when comprehending the audible speech 108. Additionally or alternatively, the user state classification module 320 can execute the at least one ML model to determine the user emotional state 306 using other types of the biometric data 302. For example, the at least one ML model can determine, from a spike in heart rate and/or pulse of the user 104, that the user 104 is confused and/or frustrated. In another example, the at least one ML model can use measured vibrations associated with the user 104 as ML input to generate ML output indicating that the user 104 is shaking or expressing signs of distress.

In some embodiments, the user state classification module 320 executes at least one NLP model to implement emotion detection. Emotion detection using NLP involves analyzing spoken words to identify and classify the emotional tone or sentiment embedded within the spoken words. For example, the user state classification module 320 can execute at least one NLP model using the user speech audio information 304 as NLP input, which may include audio data and/or speech-to-text data, to generate NLP output. The NLP output shown in FIG. 3 is the user emotional state 306. For example, the user state classification module 320 can execute at least one NLP model to perform emotion detection using the user speech audio information 304 to determine the user emotional state 306. For example, the user state classification module 320 can identify, using the user speech audio information 304, cues from speech spoken by the user 104 that the user 104 has a particular emotional state, such as a state of confusion and/or frustration.

The user state classification module 320 of the depicted example outputs the user emotional state 306 to a user comprehension determination module 330. The user comprehension determination module 330 can be configured to generate at least one speech comprehension metric 308. For example, the user comprehension determination module 330 can be configured to generate the at least one speech comprehension metric 308 using the user emotional state 306. In such an example, the user comprehension determination module 330 can generate an initial and/or preliminary value(s) of the at least one speech comprehension metric 308 during a calibration and/or configuration process of the electronic device 110 for use by the user 104. In some embodiments, the user comprehension determination module 330 can be configured to alter, change, modify, and/or update existing value(s) for the at least one speech comprehension metric 308. For example, the user comprehension determination module 330 can update the at least one speech comprehension metric 308 over time using feedback from the user 104. Examples of the feedback include the biometric data 302, the user speech audio information 304, and the user emotional state 306.

In the shown example, a cognitive speech model 340 generates and/or outputs modulated speech output 316 using at least the at least one speech comprehension metric 308 from the user comprehension determination module 330. In some embodiments, the cognitive speech model 340 is at least one ML model that can be executed using one or more ML inputs to generate the input data interface module 310 as ML output. For example, the cognitive speech model 340 can be implemented by a sequence-to-sequence model with attention.

A first input to the cognitive speech model 340 is the at least one speech comprehension metric 308. For example, the cognitive speech model 340 can modulate non-user speech audio information 314, which can represent the audible speech 108 and/or the audible speech 204 of FIGS. 1 and/or 2, in accordance with at least the at least one speech comprehension metric 308. For example, the input data interface module 310 can be configured to receive the non-user speech audio information 314 as at least part of the input information 112 and output the non-user speech audio information 314 to an acoustic feature determination module 350, a speech-to-text module 360, and a user audio preferences module 370.

A second input to the cognitive speech model 340 is user environment sound data 312. In some embodiments, the user environment sound data 312 can be and/or correspond to the environment sound 114 of FIGS. 1 and/or 2. For example, the input data interface module 310 can identify and/or extract the environment sound 114 from the input information 112 and output the environment sound 114 as the user environment sound data 312. The cognitive speech model 340 can be executed using at least the environment sound data 312 as ML input to output the modulated speech output 316 to mitigate environmental noise of the user's environment. For example, the cognitive speech model 340 can generate the modulated speech output 316 such that the user environment sound data 312 is rejected entirely or in part. In such an example, the cognitive speech model 340 can generate the modulated speech output 316 to overcome the effects of the user environment sound data 312 such as by increasing the volume output of the output information 118 of FIGS. 1 and/or 2 to the user 104.

A third input to the cognitive speech model 340 is acoustic features 318 of the non-user speech audio information 314 identified by the acoustic feature determination module 350. In FIG. 3, the acoustic feature determination module 350 can include and/or be implemented by at least one model to analyze and process speech data for acoustic feature identification. In some embodiments, the at least one model is at least one ML model configured and/or trained to process audio data. For example, the acoustic feature determination module 350 can execute at least one ML model using the non-user speech audio information 314 as ML input to generate ML output, which can include the acoustic features 318. Examples of the acoustic features 318 include duration, inflection, intonation, phasing, pitch, stress, tempo, tone, or volume. In the illustrated example, the cognitive speech model 340 can generate the modulated speech output 316 using at least the acoustic features 318. For example, the cognitive speech model 340 can modulate at least some of the acoustic features 318 of the non-user speech audio information 314 to match and/or correspond to at least some of acoustic features indicated by user audio preferences 322 of the user 104.

A fourth input to the cognitive speech model 340 is speech text data 324 output from the speech-to-text module 360. The speech-to-text module 360 can be and/or include at least one model configured to convert speech data of the non-user speech audio information 314 into text data. Examples of text data include alphanumeric characters and strings of constituent text in any linguistic structure. Examples of linguistic structures include paragraphs, sentences, sentence fragments, and words. Examples of the at least one model include an ML model. Examples of the ML model include NNs and NLP models (e.g., an automatic speech recognition (ASR) model, a transcription model, a dictation model). For example, the speech-to-text module 360 can be configured to parse audible speech represented by the non-user speech audio information 314 into one or more words, sentences, paragraphs, etc. In such an example, the speech-to-text module 360 can output the converted and/or parsed text as the speech text data 324. The speech-to-text module 360 can output the speech text data 324 to the cognitive speech model 340. For example, the cognitive speech model 340 can change and/or modify portion(s) of the non-user speech audio information 314, such as challenging words to understand (e.g., lengthy words, difficult or uncommonly used words) or complex sentence structures, into simpler speech using the speech text data 324. In such an example, the cognitive speech model 340 can analyze the speech text data 324 in accordance with the user's comprehension abilities (e.g., as indicated by the at least one speech comprehension metric 308) and output simpler speech as the modulated speech output 316.

A fifth input to the cognitive speech model 340 is the user audio preferences 322 from the user audio preferences module 370. The user audio preferences 322 represent preferences and/or desired settings of the user 104 for audio output from the electronic device 110. Examples of the user audio preferences 322 include preferences and/or desired settings for duration, inflection, intonation, phasing, pitch, stress, tempo, tone, or volume of speech for output by at least one audio output device of the electronic device 110.

In some embodiments, the user audio preferences module 370 obtains the user audio preferences 322 from the user 104 and are identified in FIG. 3 as user audio preferences from user 326. For example, the user audio preferences module 370 can receive input from the user 104 (or a different person such as a clinician or practitioner) via one or more input buttons on the electronic device 110, spoken commands by the user 104 (or the different person), and/or a software interface.

In some embodiments, the user audio preferences module 370 obtains the user audio preferences 322 by learning preferences of the user 104 over time. For example, the user audio preferences module 370 can obtain the non-user speech audio information 314 from the input data interface module 310. In such an example, the user audio preferences modules 370 can include and/or execute at least one model (e.g., at least one ML model) using the non-user speech audio information 314 as model input to generate model output, which can include identification(s) of the user audio preferences 322 or change(s) thereof.

Also shown in the example of FIG. 3 is a natural language understanding model 380 configured to present information of interest from the speech text data 324 to the user 104. In the shown example, the natural language understanding model 380 can generate visual output 328 representing speech topics for presentation to the user 104. For example, the natural language understanding model 380 can be and/or implemented at least in part by at least one ML model and/or NLP model. An example of the ML model and/or NLP model is as a Latent Dirichlet allocation (LDA) for topic modeling and intent recognition for extracting specific cues from the non-user speech audio information 314.

In such an example, the natural language understanding model 380 can summarize information represented by the speech text data 324. The natural language understanding model 380 can identify information of interest and present the identified information on at least one display device of the electronic device 110. For example, the electronic device 110 can be an AR/VR device, and the information can be presented using one or more graphical objects on one or more displays of the AR/VR device. Examples of information of interest include calendar dates and/or times of day, events and/or location(s) thereof, phone numbers, and spoken commands by the person 106. For example, the natural language understanding model 380 can determine, using the speech text data 324, that the person 106 told the user 104 about an event occurring on a particular date at a particular time. In such an example, the natural language understanding model 380 can generate one or more graphical objects that include text describing the event and event time. The natural language understanding model 380 can output the graphical object(s) for display on at least one display of the AR/VR device associated with the user 104.

In the illustrated example of FIG. 3, the cognitive speech model 340 generates the modulated speech output 316 using at least one of a plurality of inputs, such as at least one of the at least one speech comprehension metric 308, the user environment sound data 312, the acoustic features 318, the speech text data 324, or the user audio preferences 322. Beneficially, the cognitive speech model 340 can generate the modulated speech output 316 to improve the user's understanding of the non-user speech audio information 314.

In the shown example, the cognitive speech model 340 outputs the modulated speech output 316 to a speech output synthesizer module 390. The speech output synthesizer module 390 can be configured to convert the modulated speech output 316 into audio output 332 representing modulated speech output personalized to the user 104. For example, the speech output synthesizer module 390 can be implemented by a vocoder, which can be executed by one or more programmable processors that can convert the modulated speech output 316 into the audio output 332. An example of a vocoder is the WaveNet vocoder. Non-limiting examples of programmable processors include central processing units (CPUs), digital signal processors (DSPs), field programmable gate arrays (FPGAs), and graphics processing units (GPUs). The audio output 332 of the shown example can correspond to and/or implement the output information 118 of FIGS. 1 and/or 2. For example, the audio output 332 can be output via at least one audio output device of the electronic device 110.

While an example implementation of the speech understanding improvement service 102 is depicted in FIG. 3, other implementations are contemplated. For example, one or more blocks, components, functions, etc., of the speech understanding improvement service 102 may be combined or divided in any other way. The speech understanding improvement service 102 of the illustrated example may be implemented by hardware alone, or by a combination of hardware, software, and/or firmware. For example, the input data interface module 310, the user state classification module 320, the user comprehension determination module 330, the cognitive speech model 340, the acoustic feature determination module 350, the speech-to-text module 360, the user audio preferences module 370, the natural language understanding model 380, and/or the speech output synthesizer module 390, and/or, more generally, the speech understanding improvement service 102, may be implemented by one or more analog or digital circuits (e.g., comparators, operational amplifiers, etc.), one or more hardware-implemented state machines, one or more programmable processors (e.g., central processing units (CPUs), digital signal processors (DSPs), field programmable gate arrays (FPGAs), graphics processing units (GPUs), etc.), one or more network interfaces (e.g., network interface circuitry, network interface cards (NICs), smart NICs, etc.), one or more application specific integrated circuits (ASICs), one or more memories (e.g., non-volatile memory, volatile memory, etc.), one or more mass storage disks or devices (e.g., hard-disk drives (HDDs), solid-state disk (SSD) drives, etc.), etc., and/or any combination(s) thereof.

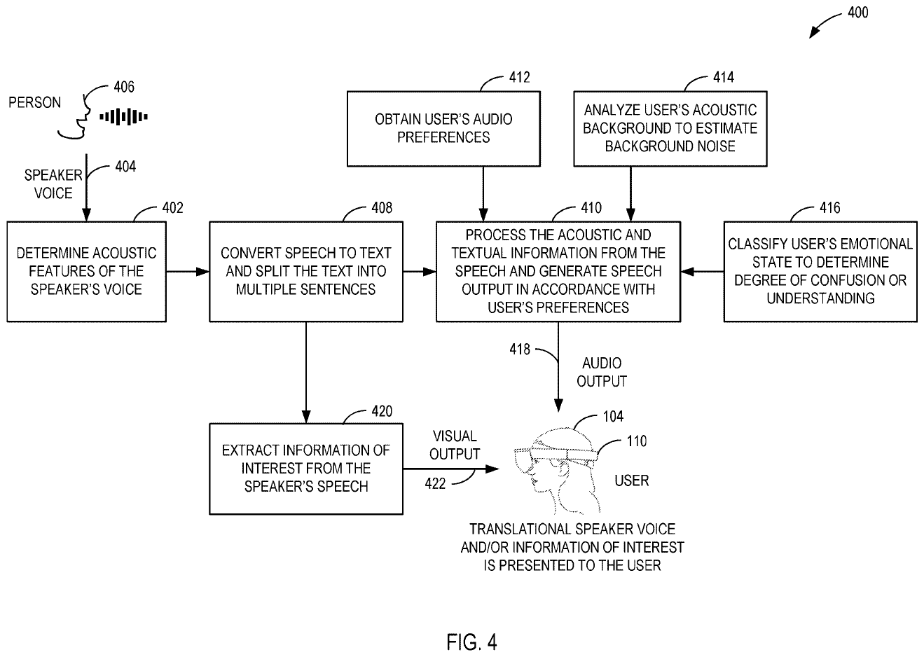

FIG. 4 is a workflow 400 of example operations that may be performed and/or executed by the speech understanding improvement service 102 of FIGS. 1, 2, and/or 3 to improve speech understanding of a user, such as the user 104 of FIGS. 1 and/or 2. The workflow 400 of FIG. 4 begins at a first operation 402, at which a speaker voice 404 of a person 406 is received and/or detected. In some embodiments, the person 406 can be the person 106 of FIGS. 1 and/or 2. In some such embodiments, the speaker voice 404 can be the voice of the person 106 and represented by the audible speech 108 of FIG. 1 and/or, the audible speech 204 of FIG. 2, and/or the non-user speech audio information 314 of FIG. 3. In some embodiments, the person 406 can be the user 104 of FIGS. 1 and/or 2. In some such embodiments, the speaker voice 404 can be the voice of the user 104 and represented by the user speech audio information 304 of FIG. 3.

During the first operation 402, the speech understanding improvement service 102 determines acoustic features of the speaker's voice. For example, the acoustic feature determination module 350 can be executed to determine the acoustic features 318 of the audible speech 108 using the non-user speech audio information 314 of FIG. 3. Additionally or alternatively, the acoustic feature determination module 350 can be executed to determine the acoustic features 318 of the user's speech using the user speech audio information 304.

During a second operation 408, the speech understanding improvement service 102 converts speech to text and splits the text into multiple sentences. For example, the speech-to-text module 360 can be executed to convert the non-user speech audio information 314 into text and split the converted text into multiple sentences. In such an example, the speech-to-text module 360 can output the split text as the speech text data 324.

During a third operation 410, the speech understanding improvement service 102 processes the acoustic and textual information from the speech and generates speech output in accordance with user's preferences. For example, the cognitive speech model 340 can generate the modulated speech output 316 in accordance with at least the user audio preferences 322 of the user 104. The speech understanding improvement service 102 can obtain the user's audio preferences during operation 412 and analyze the user's acoustic background to estimate background noise during operation 414. The speech understanding improvement service 102 can classify the user's emotional state to determine a degree of confusion or understanding during operation 416. For example, the cognitive speech model 340 can obtain the user audio preferences 322 from the user audio preferences module 370 and estimate the background noise using the user environment sound data 312. In such an example, the user state classification module 320 can classify the user emotional state 306 to determine a degree to which the user 104 comprehended the audible speech 108.

Responsive to the third operation 410, the speech understanding improvement service 102 generates and/or outputs audio output 418 to the user 104. For example, the speech output synthesizer module 390 can convert the modulated speech output 316 into the audio output 332. The audio output 418 of the shown example can be output to at least one audio output device of the electronic device 110. The electronic device 110 shown in FIG. 4 is an AR/VR device. For example, the audio output 418 representing modulated speech output personalized to the user 104 can be output via at least one speaker of the AR/VR device.

Further depicted in the workflow 400, during operation 420, the speech understanding improvement service 102 extracts information of interest from the speaker's speech. The speech understanding improvement service 102 can generate a visual output 422 to be presented to the user 104 using at least one display device of the electronic device 110. For example, the natural language understanding model 380 can identify information of interest to the user 104 from the speech text data 324. In such an example, the natural language understanding model 380 can generate the visual output 328 representing the extracted information and present it to the user 104. Accordingly, the workflow 400 can be performed and/or executed by the speech understanding improvement service 102 to present a translational speaker voice and/or information of interest to the user 104. For example, the speech understanding improvement service 102 can modulate the speech from the person 406 using the workflow 400 to present modulated speech information (e.g., audio and/or visual data) to the user 104 to improve understanding of the person's speech.

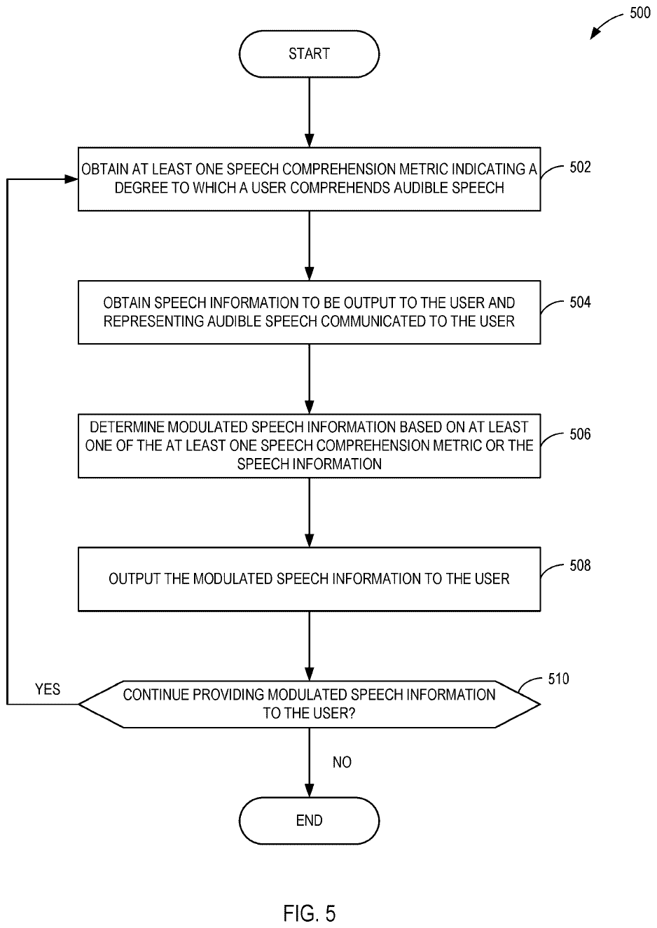

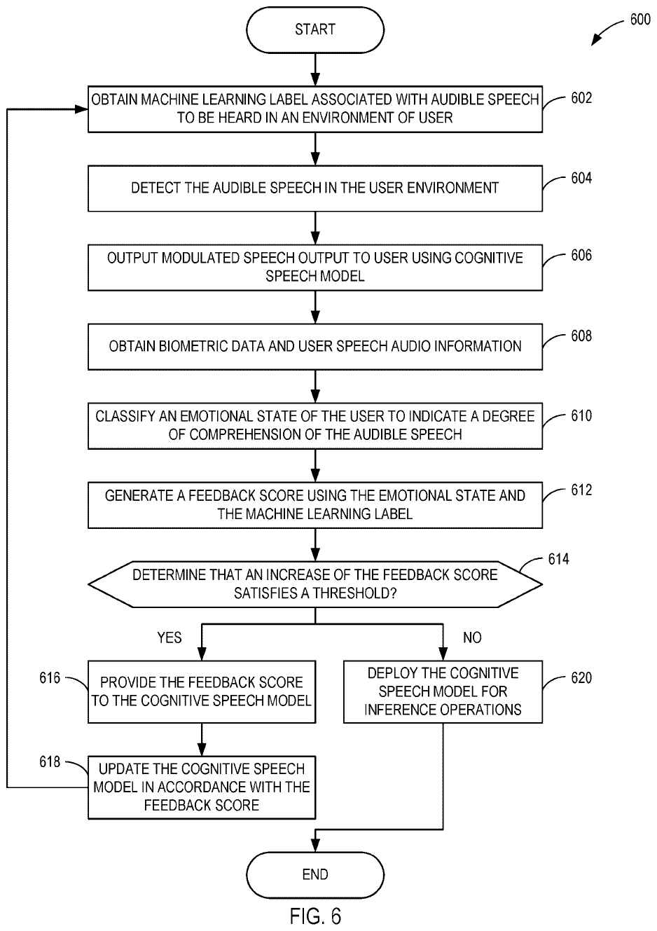

FIGS. 5 and 6 are flowcharts representative of example processes to be performed and/or example machine-readable instructions that may be executed by processor circuitry to implement the speech understanding improvement service 102 of FIGS. 1, 2, and/or 3. Additionally or alternatively, block(s) of one(s) of the flowcharts of FIGS. 5 and/or 6 may be representative of state(s) of one or more hardware-implemented state machines, algorithm(s) that may be implemented by hardware alone such as an ASIC, etc., and/or any combination(s) thereof.

FIG. 5 is a flowchart 500 representative of an example process that may be performed and/or implemented using hardware logic and/or example machine-readable instructions that may be executed by processor circuitry to implement the speech understanding improvement service 102 to output modulated speech information to a user. The flowchart 500 of FIG. 5 begins at block 502, at which the speech understanding improvement service 102 may obtain at least one speech comprehension metric indicating a degree to which a user comprehends audible speech. For example, the cognitive speech model 340 can obtain the at least one speech comprehension metric 308 indicating a degree to which the user 104 comprehends audible speech, such as the audible speech 108.

At block 504, the speech understanding improvement service 102 may obtain speech information to be output to the user and representing audible speech communicated to the user. For example, the input data interface module 310 can obtain the non-user speech audio information 314, which may represent the audible speech 108 communicated to the user 104 and to be output to the user 104 via audio output device(s) and/or display device(s).

At block 506, the speech understanding improvement service 102 may determine modulated speech information based on at least one of the at least one speech comprehension metric or the speech information. For example, the cognitive speech model 340 can be executed using at least one input, such as the at least one speech comprehension metric 308 and/or the speech text data 324, to determine the modulated speech output 316 for output to the user 104.

At block 508, the speech understanding improvement service 102 may output the modulated speech information to the user. For example, the cognitive speech model 340 can output the modulated speech output 316 to the speech output synthesizer module 390. The speech output synthesizer module 390 can generate, using the modulated speech output 316, the audio output 332 representing modulated speech output personalized to the user 104.

At block 510, the speech understanding improvement service 102 may determine whether to continue providing modulated speech information to the user. For example, the input data interface module 310 can determine whether new speech is detected in an environment of the user 104. If, at block 510, the speech understanding improvement service 102 determines to continue providing modulated speech information to the user, control returns to block 502. Otherwise, the example flowchart 500 of FIG. 5 concludes.

FIG. 6 is a flowchart 600 representative of an example process that may be performed and/or implemented using hardware logic and/or example machine-readable instructions that may be executed by processor circuitry to implement the speech understanding improvement service 102 to train a cognitive speech model for inference operations. The flowchart 600 of FIG. 6 begins at block 602, at which the speech understanding improvement service 102 may obtain a machine learning label associated with audible speech to be heard in an environment of user. For example, the input data interface module 310 can obtain a machine learning label representing an expected emotional state of the user 104 in response to hearing audible speech intended to invoke the expected emotional state of the user 104. In such an example, the input data interface module 310 can obtain a machine learning label of “very confused”, “slightly confused”, or “not confused”, or quantifications thereof, such as a value in a range of 0 to 100 (or any other range) for each of the labels. In some embodiments, the input data interface module 310 can provide the machine learning label to the user comprehension determination module 330 for later processing.

At block 604, the speech understanding improvement service 102 may detect the audible speech in the user environment. For example, the input data interface module 310 can obtain the input information 112, which may include data representing the audible speech intended to invoke the expected emotional state of the user 104.

At block 606, the speech understanding improvement service 102 may output modulated speech output to user using cognitive speech model. For example, the cognitive speech model 340 can generate the modulated speech output 316 for output to the user 104.

At block 608, the speech understanding improvement service 102 may obtain biometric data and user speech audio information. For example, the input data interface module 310 can obtain the biometric data 302 and the user speech audio information 304. In such an example, the biometric data 302 and the user speech audio information 304 can be obtained and/or generated in response to the user 104 hearing the modulated speech output 316.

At block 610, the speech understanding improvement service 102 may classify an emotional state of the user to indicate a degree of comprehension of the audible speech. For example, the user state classification module 320 can determine the user emotional state 306, which can indicate a degree to which the user 104 comprehended the modulated speech output 316.

At block 612, the speech understanding improvement service 102 may generate a feedback score using the emotional state and the machine learning label. For example, the user comprehension determination module 330 can compare the expected emotional state and the user emotional state 306. In such an example, the user comprehension determination module 330 can generate a feedback score based on the comparison. The feedback score may indicate a degree to which the observed emotional state of the user 104, such as the user emotional state 306, corresponds to and/or matches the expected emotional state of the user 104. In some embodiments, a higher value of the feedback score can indicate that the observed emotional state more closely aligns with the expected emotional state when compared to a lower value of the feedback score. For example, higher feedback score values can indicate that the cognitive speech model 340 is generating modulated speech output such that the user 104 is responding as expected (e.g., the user 104 is comprehending the modulated speech output 316 with improved understanding than if the non-user speech audio information 314 is not modulated).

At block 614, the speech understanding improvement service 102 may determine whether an increase of the feedback score satisfies a threshold. For example, the user comprehension determination module 330 can determine that the feedback score is iteratively increasing when processing subsequent samples of audible speech. In such an example, the user comprehension determination module 330 can determine that the cognitive speech model 340 is iteratively improving. For example, the user comprehension determination module 330 can determine that the value of the feedback score increased by 5 between successive audible speech samples, which exceeds a threshold score increase of 2. In some embodiments, the user comprehension determination module 330 can determine that the feedback score is decreasing or increasing at a slower than expected rate. In some such embodiments, the user comprehension determination module 330 can determine that the cognitive speech model 340 may not be substantively improved.

If, at block 614, the speech understanding improvement service 102 determines that an increase of the feedback score satisfies a threshold, control proceeds to block 616. At block 616, the speech understanding improvement service 102 may provide the feedback score to the cognitive speech model. For example, the user comprehension determination module 330 can provide the feedback score to the cognitive speech model 340 to cause retraining and/or updating of the cognitive speech model 340.

At block 618, the speech understanding improvement service 102 may update the cognitive speech model in accordance with the feedback score. For example, the cognitive speech model 340 can be retrained and/or reconfigured using the feedback score as an ML reward parameter. After updating the cognitive speech model in accordance with the feedback score at block 618, control returns to block 602 to obtain another machine learning label associated with another sample of audible speech to be heard in the environment of the user 104.

If, at block 614, the speech understanding improvement service 102 determines that an increase of the feedback score does not satisfy a threshold, control proceeds to block 620. At block 620, the speech understanding improvement service 102 may deploy the cognitive speech model for inference operations. For example, the speech understanding improvement service 102 can compile the cognitive speech model 340 into an executable construct (e.g., a binary file, an executable file, a machine learning model executable file) and/or configure the cognitive speech model 340 for inference operations. In such an example, the cognitive speech model 340 can be installed and/or executed on the electronic device 110. In some embodiments, the cognitive speech model 340 can be transmitted via one or more computer-implemented networks from at least one electronic device that trained and/or configured the cognitive speech model 340 to the electronic device 110. An example of an inference operation includes generating the modulated speech output 316 using at least one of a plurality of ML inputs. After deploying the cognitive speech model for inference operations at block 620, the example flowchart 600 of FIG. 6 concludes.

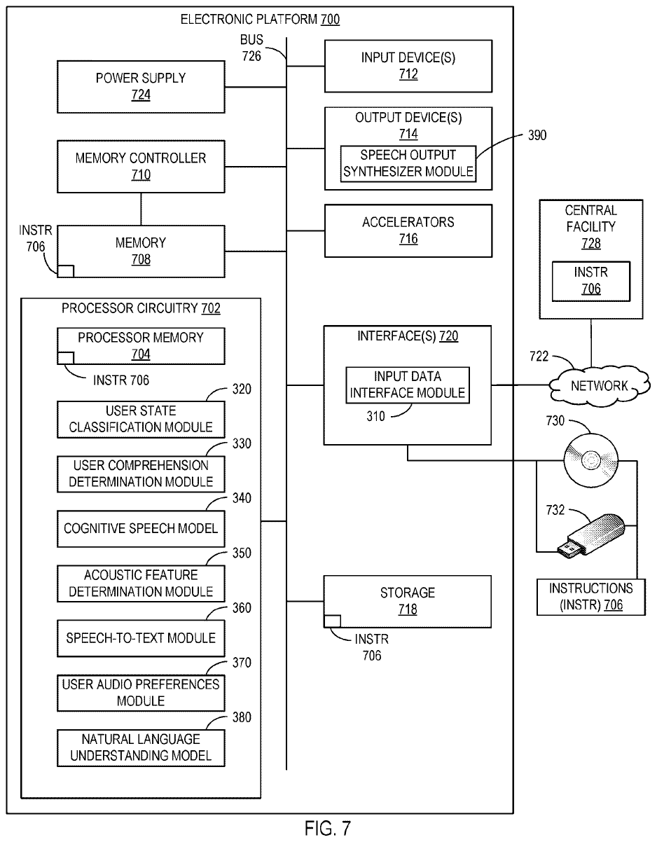

FIG. 7 is an example implementation of an electronic platform 700 structured to execute the machine-readable instructions of FIGS. 5 and/or 6 to implement the speech understanding improvement service 102 of FIGS. 1, 2, and/or 3. It should be appreciated that FIG. 7 is intended neither to be a description of necessary components for an electronic and/or computing device to operate as the speech understanding improvement service 102, in accordance with the techniques described herein, nor a comprehensive depiction. The electronic platform 700 of this example may be an electronic device, such as a handset device (e.g., a cellular network device, a smartphone, etc.), a desktop computer, a laptop computer, a tablet computer, a server (e.g., a computer server, a blade server, a rack-mounted server, etc.), a wearable device (e.g., an augmented reality and/or virtual reality (AR/VR) device, a heads-up display (HUD) device, a fitness tracker, a smartwatch, smart glasses, smart goggles, a medical device patch, a medical bracelet, etc.), a workstation, or any other type of computing and/or electronic device. In some embodiments, the electronic platform 700 implements the electronic device 110 of FIGS. 1, 2, and/or 4.

The electronic platform 700 of the illustrated example includes processor circuitry 702, which may be implemented by one or more programmable processors, one or more hardware-implemented state machines, one or more ASICs, etc., and/or any combination(s) thereof. For example, the one or more programmable processors may include one or more CPUs, one or more DSPs, one or more FPGAs, one or more GPUs, etc., and/or any combination(s) thereof. The processor circuitry 702 includes processor memory 704, which may be volatile memory, such as random-access memory (RAM) of any type. The processor circuitry 702 of this example implements the user state classification module 320, the user comprehension determination module 330, the cognitive speech model 340, the acoustic feature determination module 350, the speech-to-text module 360, the user audio preferences module 370, the natural language understanding model 380. Additionally or alternatively, the processor circuitry 702 may implement the speech output synthesizer module 390 of FIG. 3.

The processor circuitry 702 may execute machine-readable instructions 706 (identified by INSTRUCTIONS), which are stored in the processor memory 704, to implement at least one of the user state classification module 320, the user comprehension determination module 330, the cognitive speech model 340, the acoustic feature determination module 350, the speech-to-text module 360, the user audio preferences module 370, and the natural language understanding model 380. The machine-readable instructions 706 may include data representative of computer-executable and/or machine-executable instructions implementing techniques that operate according to the techniques described herein. For example, the machine-readable instructions 706 may include data (e.g., code, embedded software (e.g., firmware), software, etc.) representative of the flowcharts of FIGS. 5 and/or 6, or portion(s) thereof.

The electronic platform 700 includes memory 708, which may include the instructions 706. The memory 708 of this example may be controlled by a memory controller 710. For example, the memory controller 710 may control reads, writes, and/or, more generally, access(es) to the memory 708 by other component(s) of the electronic platform 700. The memory 708 of this example may be implemented by volatile memory, non-volatile memory, etc., and/or any combination(s) thereof. For example, the volatile memory may include static random-access memory (SRAM), dynamic random-access memory (DRAM), cache memory (e.g., Level 1 (L1) cache memory, Level 2 (L2) cache memory, Level 3 (L3) cache memory, etc.), etc., and/or any combination(s) thereof. In some examples, the non-volatile memory may include Flash memory, electrically erasable programmable read-only memory (EEPROM), magnetoresistive random-access memory (MRAM), ferroelectric random-access memory (FeRAM, F-RAM, or FRAM), etc., and/or any combination(s) thereof.

The electronic platform 700 includes input device(s) 712 to enable data and/or commands to be entered into the processor circuitry 702. For example, the input device(s) 712 may include an audio sensor, a camera (e.g., a still camera, a video camera, etc.), a keyboard, a microphone, a mouse, a touchscreen, a voice recognition system, etc., and/or any combination(s) thereof.

The electronic platform 700 includes output device(s) 714 to convey, display, and/or present information to a user (e.g., a human user, a machine user, etc.). For example, the output device(s) 714 may include one or more display devices, speakers, etc. The one or more display devices may include an augmented reality (AR) and/or virtual reality (VR) display, a liquid crystal display (LCD), a light-emitting diode (LED) display, an organic light-emitting diode (OLED) display, a quantum dot (QLED) display, a thin-film transistor (TFT) LCD, a touchscreen, etc., and/or any combination(s) thereof. The output device(s) 714 can be used, among other things, to generate, launch, and/or present a user interface. For example, the user interface may be generated and/or implemented by the output device(s) 714 for visual presentation of output and speakers or other sound generating devices for audible presentation of output. In the illustrated example, the output device(s) 714 implement the speech output synthesizer module 390 of FIG. 3, or portion(s) thereof.

The electronic platform 700 includes accelerators 716, which are hardware devices to which the processor circuitry 702 and/or the output device(s) 714 may offload compute tasks to accelerate their processing. For example, the accelerators 716 may include artificial intelligence/machine-learning (AI/ML) processors, ASICs, FPGAs, graphics processing units (GPUs), neural network (NN) processors, systems-on-chip (SoCs), vision processing units (VPUs), etc., and/or any combination(s) thereof. In some examples, one or more of the user state classification module 320, the user comprehension determination module 330, the cognitive speech model 340, the acoustic feature determination module 350, the speech-to-text module 360, the user audio preferences module 370, the natural language understanding model 380, and/or the speech output synthesizer module 390 may be implemented by one(s) of the accelerators 716 instead of the processor circuitry 702 and/or the output device(s) 714. In some examples, the user state classification module 320, the user comprehension determination module 330, the cognitive speech model 340, the acoustic feature determination module 350, the speech-to-text module 360, the user audio preferences module 370, the natural language understanding model 380, and/or the speech output synthesizer module 390 may be executed concurrently (e.g., in parallel, substantially in parallel, etc.) by the processor circuitry 702, the output device(s) 714, and/or the accelerators 716. For example, the processor circuitry 702 and one(s) of the accelerators 716 may execute in parallel function(s) corresponding to the cognitive speech model 340. In another example, the output device(s) 714 and one(s) of the accelerators 716 may execute in parallel function(s) corresponding to the speech output synthesizer module 390.

The electronic platform 700 includes storage 718 to record and/or control access to data, such as the machine-readable instructions 706. The storage 718 may be implemented by one or more mass storage disks or devices, such as HDDs, SSDs, etc., and/or any combination(s) thereof.

The electronic platform 700 includes interface(s) 720 to effectuate exchange of data with external devices (e.g., computing and/or electronic devices of any kind) via a network 722. In this example, the interface(s) 720 implements the input data interface module 310 of FIG. 3. The interface(s) 720 of the illustrated example may be implemented by an interface device, such as network interface circuitry (e.g., a NIC, a smart NIC, etc.), a gateway, a router, a switch, etc., and/or any combination(s) thereof. The interface(s) 720 may implement any type of communication interface, such as BLUETOOTH®, a cellular telephone system (e.g., a 4G LTE interface, a 5G interface, a future generation 6G interface, etc.), an Ethernet interface, a near-field communication (NFC) interface, an optical disc interface (e.g., a Blu-ray disc drive, a Compact Disk (CD) drive, a Digital Versatile Disk (DVD) drive, etc.), an optical fiber interface, a satellite interface (e.g., a BLOS satellite interface, a LOS satellite interface, etc.), a Universal Serial Bus (USB) interface (e.g., USB Type-A, USB Type-B, USB TYPE-C™ or USB-C™, etc.), etc., and/or any combination(s) thereof.

The electronic platform 700 includes a power supply 724 to store energy and provide power to components of the electronic platform 700. The power supply 724 may be implemented by a power converter, such as an alternating current-to-direct-current (AC/DC) power converter, a direct current-to-direct current (DC/DC) power converter, etc., and/or any combination(s) thereof. For example, the power supply 724 may be powered by an external power source, such as an alternating current (AC) power source (e.g., an electrical grid), a direct current (DC) power source (e.g., a battery, a battery backup system, etc.), etc., and the power supply 724 may convert the AC input or the DC input into a suitable voltage for use by the electronic platform 700. In some examples, the power supply 724 may be a limited duration power source, such as a battery (e.g., a rechargeable battery such as a lithium-ion battery).

Component(s) of the electronic platform 700 may be in communication with one(s) of each other via a bus 726. For example, the bus 726 may be any type of computing and/or electrical bus, such as an I2C bus, a PCI bus, a PCIe bus, a SPI bus, and/or the like.

The network 722 may be implemented by any wired and/or wireless network(s) such as one or more cellular networks (e.g., 4G LTE cellular networks, 5G cellular networks, future generation 6G cellular networks, etc.), one or more data buses, one or more local area networks (LANs), one or more optical fiber networks, one or more private networks, one or more public networks, one or more wireless local area networks (WLANs), etc., and/or any combination(s) thereof. For example, the network 722 may be the Internet, but any other type of private and/or public network is contemplated.

The network 722 of the illustrated example facilitates communication between the interface(s) 720 and a central facility 728. The central facility 728 in this example may be an entity associated with one or more servers, such as one or more physical hardware servers and/or virtualizations of the one or more physical hardware servers. For example, the central facility 728 may be implemented by a public cloud provider, a private cloud provider, etc., and/or any combination(s) thereof. In this example, the central facility 728 may compile, generate, update, etc., the machine-readable instructions 706 and store the machine-readable instructions 706 for access (e.g., download) via the network 722. For example, the electronic platform 700 may transmit a request, via the interface(s) 720, to the central facility 728 for the machine-readable instructions 706 and receive the machine-readable instructions 706 from the central facility 728 via the network 722 in response to the request.

Additionally or alternatively, the interface(s) 720 may receive the machine-readable instructions 706 via non-transitory machine-readable storage media, such as an optical disc 730 (e.g., a Blu-ray disc, a CD, a DVD, etc.) or any other type of removable non-transitory machine-readable storage media such as a USB drive 732. For example, the optical disc 730 and/or the USB drive 732 may store the machine-readable instructions 706 thereon and provide the machine-readable instructions 706 to the electronic platform 700 via the interface(s) 720.

### Further Examples

In some embodiments, the speech understanding improvement service 102 is a closed-loop neural network (NN) system that transforms speech in real-time to enhance intelligibility for older adults with presbycusis and/or dementia is disclosed. The speech understanding improvement service 102 may continuously adapt translations based on feedback from users to optimize listening comfort. The speech understanding improvement service 102 may extract acoustic features from input speech. These acoustic features may be translated by a sequence-to-sequence model with attention into enhanced representations optimized for the individual. A vocoder may synthesize the audio output presented to the user. Biometric sensors may monitor user state to assess comprehension to provide a feedback signal to update the translation model parameters through reinforcement learning. In some embodiments, the speech understanding improvement service 102 may implement a closed-loop neural hearing assistive system that learns to produce personalized speech enhancements tailored to each user is disclosed. The interactive learning technique beneficially improves perception, quality, and user experience for older adults with hearing decline. The speech understanding improvement service 102 can expand auditory access and improve wellbeing for users affected by age-related hearing loss.

AI/ML models, such as NNs, as disclosed herein can be configured to analyze speech and perform real-time audio translations to enhance intelligibility. In some embodiments, the electronic device 110 and/or the speech understanding improvement service 102 implement a closed-loop neural translational hearing aid that customizes speech to individual users' abilities. The speech understanding improvement service 102 may be continuously tuned based on feedback from the user to optimize their listening experience.

In some embodiments, the speech understanding improvement service 102 uses a CNN to extract acoustic features from input audio. A sequence-to-sequence model with attention translates these features to generate simplified and enhanced speech. A vocoder then synthesizes the audio output. Biometric sensors and natural language processing detect if the user 104 seems confused or frustrated. The translation model is then updated to modify its output accordingly through reinforcement learning.

This closed-loop adaptation allows the electronic device 110 and/or the speech understanding improvement service 102 to dynamically adjust to each user's needs and preferences over time. As it learns interactively during conversations, the system can improve its speech transformations to maximize listening comfort and understanding. This personalized approach could greatly enhance communication and engagement for older adults affected by hearing decline. Beneficially, the system's ability to customize tone, tempo, and complexity of speech based on real-time user feedback can improve speech understanding for the user 104 and thereby significantly improve quality of life for older adults or other persons with hearing deficits.

In some embodiments, the speech understanding improvement service 102 includes and/or implements a sequence-to-sequence model with attention that converts acoustic features into simplified speech representations. In some embodiments, the encoder is a bi-directional LSTM RNN with 256 hidden units that encodes the input features. Attention weights may be computed between the encoder output and decoder state using the Scaled Dot-Product function. In some embodiments, the decoder is a unidirectional LSTM RNN with 512 units that predicts the target sequence.

In some embodiments, the speech understanding improvement service 102 includes and/or implements a CNN that extracts acoustic features from the input waveform. In some embodiments, the CNN includes 1D convolution layers with rectified linear unit activations and max pooling for dimension reduction. In some embodiments, the final layer outputs a 64-dimension acoustic feature vector.

In some embodiments, the speech understanding improvement service 102 includes and/or implements a WaveNet vocoder to synthesize the translated speech from the sequence-to-sequence output features. For example, the WaveNet vocoder may use a dilated CNN architecture with residual blocks and gated activations to model the waveform autoregressively.

In some embodiments, the models are jointly trained to maximize quality of the final output speech based on user feedback signals. For example, the acoustic feature extractor may be trained to minimize the mean squared error between predicted features y and target features y as shown in the example of Equation (1), below, where N is the number of training samples.

$${Loss}_{feat} = \frac{1}{N} {\sum }_{i = 1}^{N} {‖ {\hat{y}}_{i} - {y}_{i} ‖}^{2} , \qquad Equation ( 1 )$$

The features may be z-normalized to have zero mean and unit variance using the training set statistics as shown in the example of Equation (2), below:

$${\hat{y}}_{norm} = \frac{{\hat{y}}_{i} - μ}{σ} , \qquad Equation ( 2 )$$

In the example of Equation (2), above, μ and σ are the estimated feature mean and standard deviation. The encoder and decoder may use units with the following formulations:

$${i}_{t} = σ ( {W}_{xi} {x}_{t} + {W}_{hi} {h}_{t - 1} + {W}_{ci} {c}_{t - 1} + {b}_{i} ) , \qquad Equation ( 3 )$$

$${f}_{t} = σ ( {W}_{x f} {x}_{t} + {W}_{h f} {h}_{t - 1} + {W}_{c f} {c}_{t - 1} + {b}_{f} ) , \qquad Equation ( 4 )$$

$${c}_{t} = {f}_{t} ⊙ {c}_{t - 1} + {i}_{t} ⊙ tanh ( {W}_{x c} {x}_{t} + {W}_{h c} {h}_{t - 1} + {b}_{c} ) , \qquad Equation ( 5 )$$

$${o}_{t} = σ ( {W}_{x o} {x}_{t} + {W}_{h o} {h}_{t - 1} + {W}_{c o} {c}_{t} + {b}_{o} ) , \qquad Equation ( 6 )$$

$${h}_{t} = {o}_{t} ⊙ tanh ( {c}_{t} ) , \qquad Equation ( 6 )$$

Where i, f, o are input, forget, and output gates, c is the cell state, h is the hidden state, σ is sigmoid, and ⊙ is elementwise multiplication.

The attention distribution aₜ may be computed as shown in the example of Equation (7), below:

$${a}_{t} = softmax ( score ( {h}_{t} , \overline{h} ) ) , \qquad Equation ( 7 )$$

Where score is the scaled dot-product function.

The loss function may be the negative log-likelihood shown in the example of Equation (8) below:

$${Loss}_{s e q 2 s e q} = - {\sum }_{t = 1}^{T} log ( p ( {y}_{t} \vert {y}_{1 : t - 1} ) ) , \qquad Equation ( 8 )$$

For interactive learning, the policy gradient, using REINFORCE algorithm, may be used for updating the model shown in the example of Equation (9) below:

$${∇}_{θ} J ( θ ) = 𝔼 [ R {∇}_{θ} log {π}_{θ} ( a \vert s ) ] , \qquad Equation ( 9 )$$

Where R is the reward, π_{θ} is the policy distribution, and a, s are actions and states. For example, R may be the feedback score as described herein.

In example operation, during conversations, biometric sensors including heart rate, skin conductance, and facial expression detection may monitor the user's state. Natural language processing may classify the user's verbal responses to determine confusion or frustration. In example operation, these signals may be aggregated to generate a feedback score in a range of feedback scores. An example feedback score range is 1-5 representing the user's comprehension of the translated speech, where 1 represents the least amount of user comprehension and 5 represents the highest amount of user comprehension. This dynamic score may be provided as the reward signal in a reinforcement learning framework to update the translation model parameters. In some embodiments, a policy gradient technique may iterate through batches of training examples. For each batch, the model generates translated speech, receives the user feedback score, and uses the user feedback score to update the model to increase future expected rewards. This interactive framework enables the model to adapt to individual users.

To evaluate operation of the speech understanding improvement service 102 various metrics and ratings may be analyzed. In some embodiments, objective intelligibility metrics including Perceptual Evaluation of Speech Quality (PESQ) and Short-Time Objective Intelligibility (STOI) may be computed between the translated and original speech. Higher scores may indicate greater preservation of linguistic content.

In some embodiments, mean opinion score (MOS) ratings may be collected from listeners comparing the adapted vs original speech. Higher MOS may indicate greater perceived quality and intelligibility. In some embodiments, feedback scores provided during conversations may be logged throughout adaptation. Improving scores may imply the model is learning to produce more accessible speech for that user. In some embodiments, the speech understanding improvement service 102 system is evaluated on a cohort of older adults with age-related hearing decline. Metrics may be monitored during active learning sessions to assess the model's ability to personalize output speech based on real-time user feedback.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a DSP circuit or an ASIC, or may be implemented in any other suitable manner. It should be appreciated that the flowcharts included herein do not depict the syntax or operation of any particular circuit or of any particular programming language or type of programming language. Rather, the flowcharts illustrate the functional information one skilled in the art may use to fabricate circuits or to implement computer software algorithms to perform the processing of a particular apparatus carrying out the types of techniques described herein. For example, the flowcharts, or portion(s) thereof, may be implemented by hardware alone (e.g., one or more analog or digital circuits, one or more hardware-implemented state machines, etc., and/or any combination(s) thereof) that is configured or structured to carry out the various processes of the flowcharts. In some examples, the flowcharts, or portion(s) thereof, may be implemented by machine-executable instructions (e.g., machine-readable instructions, computer-readable instructions, computer-executable instructions, etc.) that, when executed by one or more single- or multi-purpose processors, carry out the various processes of the flowcharts. It should also be appreciated that, unless otherwise indicated herein, the particular sequence of steps and/or acts described in each flowchart is merely illustrative of the algorithms that may be implemented and can be varied in implementations and embodiments of the principles described herein.

Accordingly, in some embodiments, the techniques described herein may be embodied in machine-executable instructions implemented as software, including as application software, system software, firmware, middleware, embedded code, or any other suitable type of computer code. Such machine-executable instructions may be generated, written, etc., using any of a number of suitable programming languages and/or programming or scripting tools, and also may be compiled as executable machine language code or intermediate code that is executed on a framework, virtual machine, or container.

When techniques described herein are embodied as machine-executable instructions, these machine-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way.

Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc., that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (e.g., as a single unit or separate units), or some of these functional facilities may not be implemented.

Machine-executable instructions (e.g., processor-executable instructions) implementing the techniques described herein (when implemented as one or more functional facilities or in any other manner) may, in some embodiments, be encoded on one or more computer-readable media, machine-readable media, etc., to provide functionality to the media. Computer-readable media, machine-readable media, etc., include magnetic media such as a hard disk drive, optical media such as a CD or a DVD, a persistent or non-persistent solid-state memory (e.g., Flash memory, Magnetic RAM, etc.), or any other suitable storage media. Such a computer-readable medium, a machine-readable medium, etc., may be implemented in any suitable manner. As used herein, the terms “computer-readable media” (also called “computer-readable storage media”), “computer-readable medium” (also called “computer-readable storage medium”), “machine-readable media” (also called “machine-readable storage media”), and “machine-readable medium” (also called “machine-readable storage medium”) refer to tangible storage media. Tangible storage media are non-transitory and have at least one physical, structural component. In a “computer-readable medium” and “machine-readable medium” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium, a machine-readable medium, etc., may be altered during a recording process.

Further, some techniques described above comprise acts of storing information (e.g., data and/or instructions) in certain ways for use by these techniques. In some implementations of these techniques—such as implementations where the techniques are implemented as machine-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as machine-executable instructions, these instructions may be executed on one or more suitable computing device(s) and/or electronic device(s) operating in any suitable computer and/or electronic system, or one or more computing devices (or one or more processors of one or more computing devices) and/or one or more electronic devices (or one or more processors of one or more electronic devices) may be programmed to execute the machine-executable instructions. A computing device, electronic device, or processor (e.g., processor circuitry) may be programmed to execute instructions when the instructions are stored in a manner accessible to the computing device, electronic device, or processor, such as in a data store (e.g., an on-chip cache or instruction register, a computer-readable storage medium and/or a machine-readable storage medium accessible via a bus, a computer-readable storage medium and/or a machine-readable storage medium accessible via one or more networks and accessible by the device/processor, etc.). Functional facilities comprising these machine-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more FPGAs for carrying out the techniques described herein, or any other suitable system.

Embodiments have been described where the techniques are implemented in circuitry and/or machine-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. A method for improving speech understanding of a user:
obtaining at least one speech comprehension metric indicating a degree to which the user comprehends audible speech;
obtaining speech information to be output to the user, the speech information representing audible speech communicated to the user;
determining modulated speech information using a cognitive speech model with the at least one speech comprehension metric and the speech information; and
outputting the modulated speech information to the user.

2. The method of claim 1, further comprising:
receiving audio information output from an audio sensor and representing the speech information;
identifying acoustic features of the speech information using an acoustic feature model with the audio information; and
obtaining user audio preference information representing audible speech output preferences of the user; and wherein
determining the modulated speech information comprises generating the modulated speech information by modulating the acoustic features in accordance with the user audio preference information.

3. The method of claim 2, wherein the acoustic features comprise at least one of a duration, an inflection, an intonation, a phasing, a pitch, a stress, a tempo, a tone, or a volume feature of the audible speech.

4. The method of claim 1, wherein obtaining the at least one speech comprehension metric comprises:
receiving biometric information associated with the user and output from one or more biometric sensors;
determining an emotional state of the user using a user state classification model with the biometric information, the emotional state representing a degree to which the user is at least one of confused or frustrated when comprehending audible speech; and
generating the at least one speech comprehension metric using the emotional state.

5. The method of claim 4, wherein the biometric information comprises at least one of facial expression information, heart rate information, or skin conductance information associated with the user.

6. The method of claim 1, wherein obtaining the at least one speech comprehension metric comprises:
receiving user speech information output from an audio sensor and representing speech spoken by the user in response to hearing of the modulated speech by the user;
determining an emotional state of the user using a user state classification model with the user speech information, the emotional state representing a degree to which the user is at least one of confused or frustrated when comprehending the modulated speech; and
generating the at least one speech comprehension metric using the emotional state.

7. The method of claim 1, wherein the modulated speech information comprises modulated speech, and wherein outputting the modulated speech information to the user comprises generating audio output representing the modulated speech for output by at least one audio output device.

8. The method of claim 7, wherein the at least one audio output device is a speaker of an audio headset, an augmented reality headset, or a virtual reality headset.

9. The method of claim 1, wherein outputting the modulated speech information to the user comprises:
generating a visual output representing information from at least one of a portion of the audible speech communicated to the user or the modulated speech information; and
outputting the visual output using at least one display device.

10. The method of claim 9, wherein the at least one display device is a display of an augmented reality headset or a virtual reality headset.

11. The method of claim 1, wherein the cognitive speech model is a machine learning model, and wherein determining modulated speech information comprises executing the machine learning model using the at least one speech comprehension metric and the speech information as inputs to the machine learning model to generate the modulated speech information as output.

12. At least one non-transitory computer-readable storage medium comprising processor executable instructions that, when executed by at least one hardware processor, cause the at least one hardware processor to at least:
obtain at least one speech comprehension metric indicating a degree to which a user comprehends audible speech;
obtain speech information to be output to the user, the speech information representing audible speech communicated to the user;
determine modulated speech information using a cognitive speech model with the at least one speech comprehension metric and the speech information; and
cause output of the modulated speech information to the user.

13. A system for improving speech understanding of a user, comprising:
at least one memory storing processor-executable instructions; and
at least one hardware processor configured to execute the processor-executable instructions to:
obtain at least one speech comprehension metric indicating a degree to which a user comprehends audible speech;
obtain speech information to be output to the user, the speech information representing audible speech communicated to the user;
determine modulated speech information using a cognitive speech model with the at least one speech comprehension metric and the speech information; and
output the modulated speech information to the user.

14. The system of claim 13, wherein the processor-executable instructions further cause the at least one hardware processor to:
receive audio information output from an audio sensor and representing the speech information;
identify acoustic features of the speech information using an acoustic feature model with the audio information; and
obtain user audio preference information representing audible speech output preferences of the user; and wherein
the processor-executable instructions cause the at least one hardware processor to determine the modulated speech information comprises generating the modulated speech information by modulating the acoustic features in accordance with the user audio preference information.

15. The system of claim 14, wherein the acoustic features comprise at least one of a duration, an inflection, an intonation, a phasing, a pitch, a stress, a tempo, a tone, or a volume feature of the audible speech.

16. The system of claim 13, wherein the processor-executable instructions cause the at least one hardware processor to obtain the at least one speech comprehension metric by:
receiving biometric information associated with the user and output from one or more biometric sensors;
determining an emotional state of the user using a user state classification model with the biometric information, the emotional state representing a degree to which the user is at least one of confused or frustrated when comprehending audible speech; and
generating the at least one speech comprehension metric using the emotional state.

17. The system of claim 16, wherein the biometric information comprises at least one of facial expression information, heart rate information, or skin conductance information associated with the user.

18. The system of claim 13, wherein the processor-executable instructions cause the at least one hardware processor to obtain the at least one speech comprehension metric by:
receiving user speech information output from an audio sensor and representing speech spoken by the user in response to hearing of the modulated speech by the user;
determining an emotional state of the user using a user state classification model with the user speech information, the emotional state representing a degree to which the user is at least one of confused or frustrated when comprehending the modulated speech; and
generating the at least one speech comprehension metric using the emotional state.

19. The system of claim 13, wherein the processor-executable instructions cause the at least one hardware processor to output the modulated speech to the user by generating audio output representing the modulated speech for output by at least one audio output device.

20. The system of claim 19, wherein the at least one audio output device is a speaker of an augmented reality headset, a virtual reality headset, or an audio headset.

21. The system of claim 13, wherein the processor-executable instructions cause the at least one hardware processor to output the modulated speech to the user by:
generating a visual output representing information from at least one of a portion of the audible speech communicated to the user or the modulated speech; and
outputting the visual output using at least one display device.

22. The system of claim 21, wherein the at least one display device is a display of an augmented reality headset.

23. The system of claim 13, wherein the cognitive speech model is a machine learning model, and wherein the processor-executable instructions cause the at least one hardware processor to determine modulated speech information by executing the machine learning model using the at least one speech comprehension metric and the speech information as inputs to the machine learning model to generate the modulated speech information as output.
